(19) United States
(12) Patent Application Publication
(10) Pub. No.: US 2008/0139214 A1
(43) Pub. Date: Jun. 12, 2008

(54) METHODS AND APPARATUS FOR ALLOCATING CELL RADIO NETWORK TEMPORARY IDENTITY

(75) Inventors: Chengjun SUN, Beijing (CN); Yujian Zhang, Beijing (CN); Xiaoqiang Li, Beijing (CN); Ju-Ho Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); BEIJING SAMSUNG TELECOM R&D CENTER, Beijing (CN)

(21) Appl. No.: 11/861,908

(22) Filed: Sep. 26, 2007

(30) Foreign Application Priority Data
Sep. 26, 2006 (CN) 200610140644.6

(51) Int. Cl. H04Q 7/20

(52) U.S. Cl. 455/450

(57) ABSTRACT

The present invention describes that the C-RNTIs are grouped based on the random access preamble sequence, the transmission sub-frame and the transmission random access channel information used for the user equipment and detected by the base station. In such a way, the indicating information bits needed by C-RNTI allocation are decreased and the signaling overhead needed by C-RNTI allocation is also decreased. In addition, the random access process is optimized and the random access performance is improved.

### PRIORITY

This application claims priority under 35 U.S.C. § 119(a) to a Chinese Patent Application filed in the Chinese Intellectual Property Office on Sep. 26, 2006 and assigned Serial No. 200610140644.6, the contents of which are incorporated herein by reference.

### BACKGROUND OF THE INVENTION

1. Field of the Invention

This invention relates to a mobile wireless communication system, more specifically, to an allocation method of cell radio network temporary identity (C-RNTI) used for asynchronous random access process.

2. Description of the Related Art

Now, the 3^{rd} Generation Partnership Project (referred to as 3GPP) standardization organization has commenced on Long-term Evolution (referred to as LTE) to existing system criteria. According to the current discussion about LTE, an orthogonal frequency division multiplexing (OFDM) technology will be used as downlink physical transmission technology of LTE, while the single carrier frequency division multiple address access (simplified as SC-FDMA) will be used as an uplink physical layer transmission technology of LTE.

In a LTE communication system, the random access process is a very important process. The random access process can be divided into a synchronous random access process and an asynchronous random access process. Asynchronous random access process is used for the connection of initial physical channels and the resource request for uplink scheduling.

The purposes that the user equipment sends asynchronous random access requests to the network end include:

Timing adjustment of the receiving network end to acquire uplink synchronization.

Applying the user equipment for the identifier allocation from network end, that is applying cell radio network temporary identity (C-RNTI) allocation from network end;

Sending an uplink resource request to transmit Radio Resource Control (RRC) messages, Non Access Stratum (NAS) messages, and Layer2/Layer3 (L2/L3) messages of scheduling request information.

According to the current LTE discussion about asynchronous random access channel, the asynchronous random access process includes the following interactive processes:

the first step, the user equipment sends a random access preamble sequence to the network end;

Only the random access preamble signals are sent in this step. Random access preamble signals may carry a very limited amount of information. The user equipment can send information in four to six bits through the random access preamble signal impliedly.

the second step, the network end sends response information of the ransom access preamble sequence to the user equipment;

This response information contains the timing adjustment calculated from the random access preamble signal, and the uplink resource allocated for the user equipment to send the follow-up information. It should be noted that this response information may or may not contain the CRNTI allocated to the user equipment.

the third step, the user equipment send a Layer2/Layer3 (L2/L3) message through the uplink resource allocated by the network for it;

This L2/L3 message includes Radio Resource Control (RRC) messages, Non Access Stratum (NAS) messages, and Layer2/Layer3 (L2/L3) messages of scheduling request information.

the fourth step, the network end sends the response of L2/L3 message to the user equipment;

If the network end did not allocate the CRNTI to the user equipment in the random access response of the second step, then in this step, it will be allocated to the user equipment.

At present, some companies propose that when the user equipment sends random preamble access sequence to the network end, the preamble sequence will be used to indicate Cause information that initiates the asynchronous random access. The method of indication is to group the preamble sequences. The preamble sequences of different groups will indicate different asynchronous random access causes. The indicating asynchronous random access Causes are shown in the following Table 1:

TABLE 1
Asynchronous random access Cause

| | Does the user |
|---|---|
| Cause | equipment have CRNTI or not? |
| Initial access | No |
| Radio resource control re- | |
| establishment | |
| (RRC re-establishment) | |
| Handover failure (HO failure) | |
| Uplink data transmission | Yes |
| Uplink synchronization | |
| corresponding to downlink data | |
| transmission. | |
| Handover complete(HO complete) | |

From the above table, it can be seen that, if the cause indicated by the preamble sequence which is sent by the user equipment and received by the network end shows that the user equipment has or does not have C-RNTI, then with the C-RNTI, the network end need not allocate C-RNTI to the user equipment.

There are two methods of allocating C-RNTI:

One method is that, as described in the forth step, the C-RNTI allocation is sent through the response message of L2/L3 message which is sent from the network end to the user equipment.

The other method is that, as described in the second step, the allocation is sent through the response message of random access preamble sequence which is sent by the network end.

For the first method, the C-RNTI allocation is sent through the response message of L2/L3 message which is sent from the network end to the user equipment. Then in the second step, the C-RNTI allocation doesn't exist in the response message of random access preamble sequence which is sent from the network end to the user equipment. Therefore, there should be an implicit CRNTI (I-CRNTI) in the message to identify the user equipment before the network end allocates the C-RNTI for the user equipment.

I-CRNTI is a reserved C-RNTI subset in the whole C-RNTI space, and is specially used to represent the user equipment before the user equipment doesn't get the C-RNTI allocation in the process of random access process. Each I-CRNTI in this subset corresponds to a preamble sequence or a combination of preamble sequence and a sub-frame number or a combination of preamble sequence, sub-frame number and random access channel serial number in frequency domain. Then, when the user equipment chooses the random preamble sequence or random preamble sequence and the transmitted sub-frame or the random preamble sequence, the transmitted sub-frame and the transmitted serial number of random access channel in frequency domain, it will know the I-CRNTI for it, which realizes that although the C-RNTI is not allocated, the message that is sent from the network end to the user equipment can be received according to the I-CRNTI.

The advantage of this method is that there is no C-RNTI allocation before the complete solution of random collision which avoids the signaling overhead brought by C-RNTI allocation. However, the disadvantage of this method is that the C-RNTI space needs to reserve extra space for I-CRNTI. If the I-CRNTI corresponds to the preamble sequence, since different subscribers may initiate random access in different time or different frequency while using the same preamble sequence, the network end needs to not only transmit the I-CRNTI but also instruct the user equipment to send the sub-frame number of preamble sequence and the serial number of the transmission channel in frequency domain when sending messages to the user equipment, which may in turn cause extra signaling overhead. If the I-CRNTI corresponds to the combination of the preamble sequence, the sub-frame number and the channel serial number in frequency domain, the corresponding reserved space will be larger.

For the second method of C-RNTI allocation, the network end allocates the C-RNTI in the response message of the preamble sequence directly. In such a way, the response message of the preamble sequence will contain the identifier RA_ID which corresponds to the preamble sequence, the uplink resource allocation, the timing adjustment and the C-RNTI. Although this method allows the user equipment to acquire the C-RNTI allocation earlier, if C-RNTI is allocated to the user equipment at this time, the signaling overhead is heavy. Since the length of C-RNTI sequence is longer and the network end can not acquire accurate channel quality information when sending the response message of the preamble sequence to the user equipment. In addition, some companies propose to send the response message of the random access preamble sequence to the user equipment using the L1/L2 control channel. Although transmitting the response message of the random access preamble sequence using L1/L2 control channel can avoid signaling overhead needed by the allocation of the downlink shared data channel, the overhead of transmitting C-RNTI is heavy, which makes the transmitting of C-RNTI allocation using L1/L2 control channel almost impossible.

Therefore it is necessary to improve the C-RNTI allocation mode to decrease the corresponding single overhead of C-RNTI allocation, then to optimize the random access process and improve the performance of random access.

### SUMMARY OF THE INVENTION

Therefore an object of present invention is to provide a method for allocating a C-RNTI by a base station, comprising steps of:

a) a user equipment sending a random access preamble sequence to the base station;

b) the base station sending a response message of the random access preamble sequence to the user equipment, the message including Uplink resource assignment information, Timing adjustment information, and information combined with a Random access preamble sequence ID to indicate the CRNTI;

c) the user equipment sending a L3 message to a network end; and

d) the network end sending a response of the L3 message to the user equipment.

With the method proposed, the C-RNTIs are grouped based on the random access preamble sequence, the transmission sub-frame and the transmission random access channel information used for the user equipment and detected by the base station. In such a way, the indicating information bits needed by C-RNTI allocation are decreased and the signaling overhead needed by C-RNTI allocation is also decreased. In addition, the random access process is optimized and the random access performance is improved.

### BRIEF DESCRIPTION OF THE DRAWINGS

FIG. 1 shows an operation flow of a base station according to a first embodiment of C-RNTI allocation method in present invention;

FIG. 2 shows an operation flow of user equipment according to a first embodiment of C-RNTI allocation method in present invention;

FIG. 3 shows a random access signaling interaction process of sending C-RNTI allocation in a response message of a preamble sequence;

FIG. 4 shows a random access signaling interaction process of sending C-RNTI allocation in a response message of a L2/L3 message;

FIG. 5 shows an operation flow of a base station according to a second embodiment of C-RNTI allocation method in present invention;

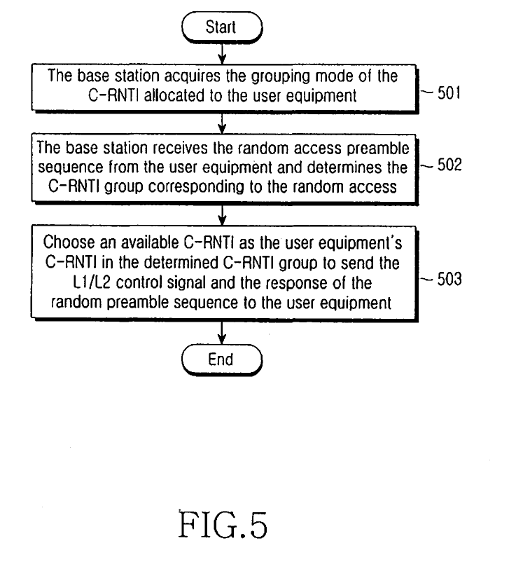

FIG. 6 shows a format of response message of a random access preamble sequence which is sent by a base station to a user equipment;

FIG. 7 shows an operation flow of a user equipment according to the second embodiment of C-RNTI allocation method in present invention;

FIG. 8 shows a signaling interaction process between a user equipment and a base station according to the second embodiment of C-RNTI allocation method in present invention;

FIG. 9 is a block diagram of a base station according to the C-RNTI allocation method in present invention;

FIG. 10 shows a format of response message of the random access preamble sequence which is transmitted in the L1/L2 control signaling;

FIG. 11 is a block diagram of C-RNTI allocation according to the base station in this invention embodiment.

### DETAILED DESCRIPTION OF THE PREFERRED EMBODIMENTS

The method for allocating C-RNTI according to present invention may decrease the number of information bits required for C-RNTI allocation by grouping the C-RNTI space. In particular, the C-RNTI space is grouped based on the random access preamble sequence, or the combination of the random access preamble sequence and the serial number of random access sub-frame, or the combination of the random access preamble sequence, the serial number of random access sub-frame and the serial number of the random access channel in frequency domain. Then the network end determines the group to which the CRNTI allocated to the user belongs according to preamble sequence chosen by the user equipment to sent random access, or the chosen preamble sequence and the number of the transmission sub-frame, or the chosen preamble sequence, the number of the transmission sub-frame and the number of the transmission channel in frequency domain, and selects an unused C-RNTI from the group determined to allocate to the user. Since the C-RNTI available to allocate just a subset in the whole C-RNTI space, the number of information bits required for indicating the allocated C-RNTI in the subset is less than that required for indicating the allocated C-RNTI in the whole C-RNTI space, so that the corresponding signaling overhead for indicating the C-RNTI may be reduced.

The invention proposes a method for allocating C-RNTI, and proposes an apparatus for realizing the method.

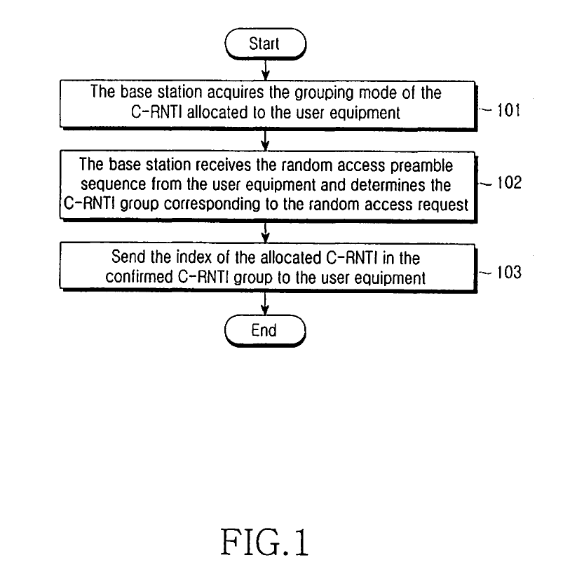

First, this invention gives a first embodiment of realizing the proposed C-RNTI allocation method. The operation flow operated by the base station in this embodiment is shown in FIG. 1.

First, the base station gets a grouping mode of the C-RNTI allocated to the user equipment (101). The method for the base station to acquire the grouping mode of the C-RNTI allocated to the user equipment may be a C-RNTI grouping mode according to the well-known specifications (such as 3GPP specifications). Also other nodes of the network end may configure the grouping mode and inform the base station through signaling. In addition, the base station may determine the C-RNTI grouping mode itself. For instance, the base station may determine the C-RNTI grouping mode according to its own configuration of random sequence and random channel, or according to the configuration of random sequence and/or the configuration of random channel of other nodes in the network end.

After that, the base station receives the random access preamble sequence from the user equipment and determines the C-RNTI group corresponding to the random access request (102).

Then, the base station determines the C-RNTI group allocated to the user equipment, and chooses a C-RNTI to send the C-RNTI assignment to the user equipment (103). In particular, the embodiment includes steps of: the base station choosing an unallocated C-RNTI in the determined C-RNTI group, and sending the chosen C-RNTI's number in this group to the user equipment when it is needed to allocate C-RNTI to the user equipment to realize C-RNTI assignment.

In step 103, the C-RNTI assignment that the base station sends to the user equipment may be transmitted in the response message of the random access preamble sequence, also it can be transmitted in the response message of Layer2/Layer3 (L2/L3) message that the base station sends to the user equipment. If the transmission occurs in the response message of the random access preamble sequence, then the C-RNTI assignment may be transmitted through Layer1/Layer2 (L1/L2) control channel also may be transmitted through the downlink shared data channel.

It should be noted that according to the above allocation method of C-RNTI grouping, there may be C-RNTI exhaustion in a certain C-RNTI group. To avoid the occurrence of C-RNTI exhaustion, the above allocation method may include steps of: the base station sending a C-RNTI re-allocation signaling to the user equipment that has completed the process of random access.

The base station sends C-RNTI re-allocation signaling to the user equipment that has completed the process of random access. The user equipment may use the C-RNTI in other groups and release the C-RNTI in the primary C-RNTI group, which can avoid C-RNTI allocation exhaustion in some C-RNTI groups.

There are several modes for the grouping of the C-RNTI space allocated to the user equipment in the method of this invention:

C-RNTI space grouping mode 1:

C-RNTI space grouping mode 1 is a grouping mode based on the random access preamble sequence. If we assume that the number of the preamble sequence used for grouping is N_{RS}, then a grouping mode can be obtained as shown in Formula (1). We assume that the number of C-RNTI in the whole C-RNTI space is N_{T}, and the index of the C-RNTI is n in the whole C-RNTI space, then the index of that CRNTI (whose index is n) in the group is n_{g}:

n_{g}=n mod N_{RS} 0≦n≦N_{T} (1)

According to Formula (1), the C-RNTI grouping mode based on the preamble sequence is shown in Table 2:

TABLE 2
A grouping mode of C-RNTI space
based on the preamble sequence

| C-RNTI | Preamble sequence | | | |
|---|---|---|---|---|
| allocation | Sequence 1 | Sequence 2 | | Sequence N_{RS} |
| indication | Group 1 | Group 2 | . . . | Group N_{RS} |
| 0 . . . 001 | C-RNTI 1 | C-RNTI 2 | . . . | C-RNTI N_{RS} |
| 0 . . . 010 | C-RNTI N_{RS} + 1 | C-RNTI N_{RS} + 2 | . . . | C-RNTI 2N_{RS} |
| 0 . . . 011 | C-RNTI 2N_{RS} + 1 | C-RNTI 2N_{RS} + 2 | . . . | C-RNTI 3N_{RS} |
| 0 . . . 100 | C-RNTI 3N_{RS} +1 | C-RNTI 3N_{RS} + 2 | . . . | C-RNTI 4N_{RS} |
| . . . | . . . | . . . | . . . | . . . |

C-RNTI space grouping mode 2:

C-RNTI space grouping mode 2 is a grouping mode based on the combination of the random access preamble sequence and transmission sub-frame (or transmission frame). The purpose of C-RNTI grouping based on transmission sub-frame (or transmission frame) is to group the C-RNTI group by referring to the time of random access. It is assumed that the number of the preamble sequences used for grouping is N_{RS}, while the number of sub-frames (or frame) of random access in a period of random access transmission is N_{FN}, then a grouping mode can be gotten as shown in Formula (2). It is assumed that the number of C-RNTI in the whole C-RNTI space is N_{T}, and the index of the C-RNTI in the whole C-RNTI space is n, then the index of that CRNTI (whose index is n) in the group is n_{g}:

n_{g}=n mod(N_{RS}*N_{FN}) 0≦n≦N_{T} (2)

According to Formula (2), the C-RNTI grouping mode based on the combination of the preamble sequence and transmission sub-frame (or transmission frame) is shown in Table 3:

TABLE 3
C-RNTI space grouping mode based on the combination of the preamble
sequence and transmission sub-frame (or transmission frame)

| | Transmission sub-frame (or transmission frame) | | | |
|---|---|---|---|---|
| | Transmission sub-frame | | Transmission sub-frame | |
| | 1(or transmission frame 1) | | NFN (or transmission frame N_{FN}) | |
| | Preamble sequence | | Preamble sequence | |
| [symbol] -RNTI | | Sequence N_{RS} | Sequence 1 | Sequence N_{RS} |
| allocation | Sequence 1 | Group | Group | Group |
| indication | Group 1 | N_{RS} | N_{RS}*(N_{FN} − 1) + 1 | N_{RS}*N_{FN} |
| [symbol] . . . 001 | C-RNTI 1 | C-RNTI N_{RS} | C-RNTI N_{RS}*(N_{FN} − 1) + 1 | C-RNTI N_{RS}*N_{FN} |
| [symbol] . . . 010 | C-RNTI N_{RS}*N_{FN} + 1 | C-RNTI N_{RS}*(N_{FN} + 1) | C-RNTI N_{RS}*(2N_{FN} − 1) + 1 | C-RNTI 2N_{RS}*N_{FN} |
| [symbol] . . . 011 | C-RNTI 2N_{RS}*N_{FN} + 1 | N_{RS}*(2N_{FN} + 1) | C-RNTI N_{RS}*(3N_{FN} − 1) + 1 | C-RNTI 3N_{RS}*N_{FN} |
| [symbol] . . . 100 | C-RNTI 3N_{RS}*N_{FN} + 1 | N_{RS}*(3N_{FN} + 1) | C-RNTI N_{RS}*(4N_{FN} − 1) + 1 | C-RNTI 4N_{RS}*N_{FN} |
| [symbol] | . . . | . . . | . . . | . . . |

[symbol]

indicates data missing or illegible when filed

C-RNTI space grouping mode 3:

C-RNTI space grouping mode 3 is a grouping mode based on the combination of the random access preamble sequence, transmission sub-frame (or transmission frame) and the transmitted serial number of the random access channel in frequency domain. The purpose of C-RNTI grouping based on the serial number of the random access in frequency domain is to group the C-RNTI group referring to the frequency of random access. It is assumed that the number of the preamble sequences for grouping is N_{RS}, while the number of sub-frames (or frame) of random access in a period of random access transmission is N_{FN}, then a grouping mode can be gotten as shown in Formula (3). It is assumed that the number of C-RNTI in the whole C-RNTI space is N_{T}, and the index of the C-RNTI in the whole C-RNTI space is n, then the index of that CRNTI (whose index is n) in the group is n_{g}:

n_{g}=n mod(N_{RS}*N_{FN}*N_{CN}) 0≦n≦N_{T} (3)

According to Formula (3), the C-RNTI grouping mode based on the combination of the preamble sequence, transmission sub-frame (or transmission frame) and the transmitted serial number of the random access channel in frequency domain is shown in Table 4:

TABLE 4
C-RNTI space grouping mode based on the combination of the preamble sequence, transmission sub-frame (or
transmission frame) and the transmitted serial number of the random access channel in frequency domain.

| | The serial number of random access channel in a random access transmission sub-frame (or frame) | | | |
|---|---|---|---|---|
| | Random access channel 1 | | | |
| | transmission sub-frame (or frame) | | | |
| | transmission sub- | | transmission sub- | |
| | frame 1 (or frame 1) | | frame NFN (or frame NFN) | |
| C-RNTI | Preamble sequence | | Preamble sequence | |
| Allocation | Sequence | Sequence | Sequence | Sequence |
| indication | 1 | NRS | 1 | NRS |
| 0 . . . 001 | Group | Group | Group | Group |
| | 1 | NRS | N_{RS}*(N_{FN} − 1) + 1 | N_{RS}*N_{FN} |
| 0 . . . 010 | C-RNTI 1 | C-RNTI | C-RNTI | C-RNTI |
| | | NRS | N_{RS}*(N_{FN} − 1) + 1 | N_{RS}*N_{FN} |
| 0 . . . 011 | C-RNTI | C-RNTI | C-RNTI | C-RNTI |
| | NRS*NFN*NCN + 1 | NRS*(NFN*NCN + 1) | N_{RS}*N_{FN}*(N_{CN} + 1) − N_{RS} + 1 | N_{RS}*N_{FN}*(N_{CN} + 1) |
| 0 . . . 100 | C-RNTI | . . . | . . . | . . . |
| | 2NRS*NFN*NCN + 1 | | | |
| . . . | . . . | . . . | . . . | . . . |

| | The serial number of random access channel in a random access transmission sub-frame (or frame) | |
|---|---|---|
| | Random access channel N_{CN} | |
| | transmission sub-frame (or frame) | |
| | transmission sub- | transmission sub- |
| | frame 1 (or frame 1 ) | frame N_{FN} (or frame N_{FN} |
| C-RNTI | Preamble sequence | Preamble sequence |

| Allocation | Sequence | Sequence | Sequence | Sequence |
|---|---|---|---|---|
| indication | 1 | N_{RS} | 1 | N_{RS} |
| 0 . . . 001 | Group | Group | Group | Group |
| | N_{RS}*N_{FN}*(N_{CN} − | N_{RS}*N_{FN}*(N_{CN} − | N_{RS}*(N_{FN}*N_{CN} − | N_{RS}*N_{FN}*N_{CN} |
| | 1) + 1 | 1) + N_{RS} | 1) + 1 | |
| 0 . . . 010 | C-RNTI | C-RNTI | C-RNTI | C-RNTI |
| | N_{RS}*N_{FN}*(N_{CN} − | N_{RS}*N_{FN}*(N_{CN} − | N_{RS}*(N_{FN}*N_{CN} − | N_{RS}*N_{FN}*N_{CN} |
| | 1) + 1 | 1) + N_{RS} | 1) + 1 | |
| 0 . . . 011 | C-RNTI | C-RNTI | C-RNTI | C-RNTI |
| | N_{RS}*N_{FN}*(2N_{CN} − | N_{RS}*N_{FN}*(2N_{CN} − | N_{RS}*(2N_{FN}*N_{CN} − | 2N_{RS}*N_{FN}*N_{CN} |
| | 1) + 1 | 1) + N_{RS} | 1) + 1 | |
| 0 . . . 100 | . . . | . . . | C-RNTI | C-RNTI |
| | | | N_{RS}*(3N_{FN}*N_{CN} − | 3N_{RS}*N_{FN}*N_{CN} |
| | | | 1) + 1 | |
| . . . | . . . | . . . | . . . | . . . |

As shown in Table 1, the random access preamble sequence can indicate different causes. Some of the causes show that the user equipment has the C-RNTI, while some causes show that the user equipment does not have C-RNTI. It is assumed that the number of sequence which indicates that the user equipment does not have C-RNTI is N_{NC}, and then the number of preamble sequence for grouping in the three kinds of C-RNTI grouping modes given here is N_{RS}. N_{RS} may be equal to N_{NC}, or be less than N_{NC}.

Using the given C-RNTI grouping mode, when receiving the random access preamble sequence sent by the user equipment, the network end may determine the group that the C-RNTI needed to be allocated to the subscriber belongs to according to the preamble sequence, or the combination of the preamble sequence and transmission sub-frame (or frame), or the combination of preamble sequence, transmission sub-frame (frame) and the serial number of the random access channel in frequency domain, and then choose a unused C-RNTI in this group, send the index of this C-RNTI in this group to the user equipment to realize C-RNTI allocation.

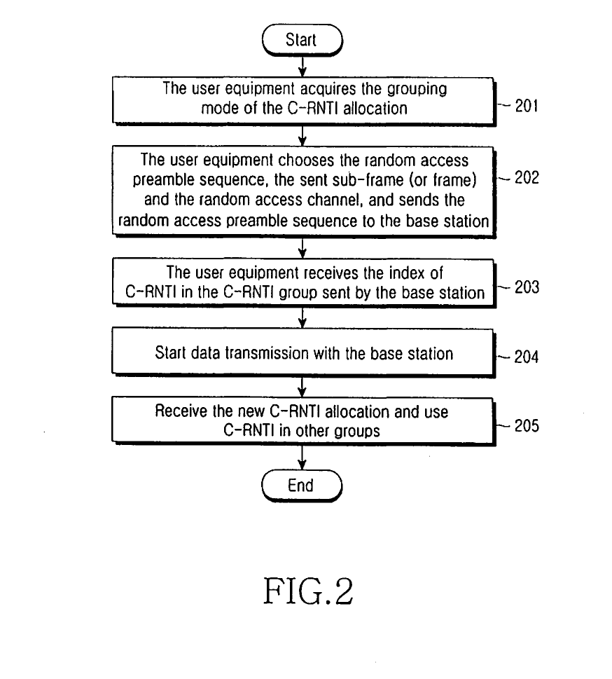

This invention proposes the operation flow of the user equipment in the first mode of C-RNTI allocation method, as shown in FIG. 2.

First, the user equipment acquires the grouping mode of the C-RNTI allocation (201). The C-RNTI grouping mode acquired by the user equipment may be fixed according to specifications. The network end also may configure the grouping mode and inform it to the user equipment. In addition, the user equipment also may determine the grouping mode itself according to the configuration of random sequence or the configuration of random channel of the network end.

After that, when the random access needs to be initiated, the user equipment chooses the random access preamble sequence, chooses the transmission sub-frame (or frame), chooses the random access channel, and sends the random access preamble sequence to the base station (202).

Then, the user equipment receives the index of C-RNTI in the C-RNTI group sent by the base station (203), and determines the group that the allocated C-RNTI belongs to according to the sent random access preamble sequence, or the combination of the preamble sequence and the transmission sub-frame (or frame), or the combination of the preamble sequence, the transmission sub-frame (or frame) and the sent random access channel, referring to the acquired grouping mode, and determines the allocated C-RNTI according to the group and index of C-RNTI.

After completing the random access process, the user equipment starts the data transmission with the base station (204).

After completing the random access process, if the base station allocates new C-RNTI to the user equipment, the user equipment receives the new C-RNTI sent by the base station and uses the new C-RNTI (205).

According to the method proposed by this invention, the base station sends the C-RNTI assignment which is the index of the C-RNTI in the group. The allocation can be transmitted in the second step of the random access process described previously, which means that the allocation is transmitted in the response message of the random access preamble sequence which is sent by the base station to the user equipment. Also the allocation can be transmitted in the fourth step of the random access process described previously, which means that the allocation is transmitted in the response message of the L2/L3 message which is sent by the base station to the user equipment.

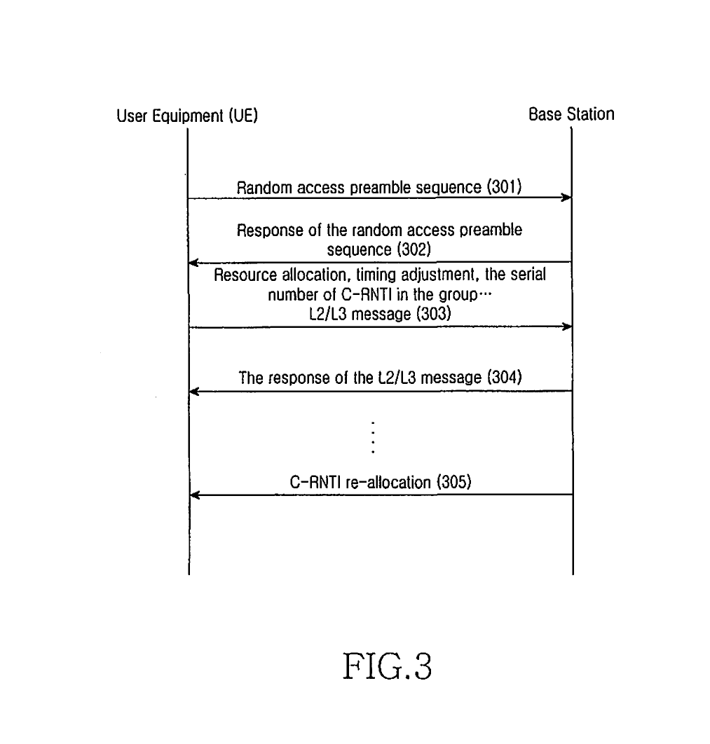

If the index of C-RNTI in the group sent by the base station is transmitted in the response message of the random access preamble sequence, then the signaling interaction between the base station and the user equipment is shown in FIG. 3.

First, the user equipment sends the random access preamble sequence to the base station (301).

Next, the base station sends the response message of the random access preamble sequence to the user equipment (302). The message contains: uplink resource allocation, timing adjustment, and index of the C-RNTI in the group that the base station allocated to the user equipment.

After that, the user equipment will send L2/L3 message to the network end (303).

Then, the network end will send the response of the L2/L3 message to the user equipment (304).

After the user equipment has completed the random access process, if the C-RNTI is almost exhausted in the C-RNTI group that the C-RNTI used by the subscriber belongs to, then the network end will send the C-RNTI re-allocation message (305) to allocate a new C-RNTI in other groups to the user equipment.

Here, in Step 302, the random access preamble sequence that the base station sends to the user equipment may contain: uplink resource allocation information, timing adjustment information, random access preamble sequence ID (RA_ID), and the information combined with RA_ID to indicate CRNTI. In the above description, the information combined with RA_ID to indicate CRNTI can be the index of the C-RNTI in the CRNTI group that the base station allocates to the user equipment.

In the above description, in step 302, the index of the allocated C-RNTI in the group can be transmitted not only in the Layer1/Layer2 control channel (L1/L2 control channel), but also in the downlink shared channel (DL-SCH).

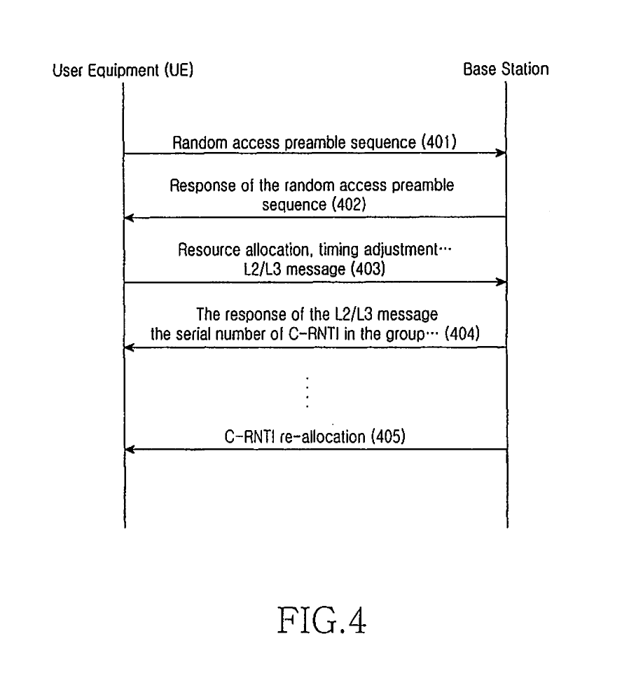

If the index of C-RNTI sent by the base station in the group is transmitted in the response message of L2/L3 message, the signaling interaction between the base station and the user equipment is shown in FIG. 4.

First, the user equipment sends the random access preamble sequence to the base station (401).

Second, the base station sends the response message of the random access preamble sequence to the user equipment (402). The message contains: uplink resource allocation, timing adjustment, and so on.

After that, the user equipment will send L2/L3 message to the network end (403).

Then, the network end will send the response of the L2/L3 message to the user equipment (404). This message will contain the index information of C-RNTI which is sent by the base station to the user equipment in the group.

After the user equipment has completed the random access process, if the C-RNTI is almost exhausted in the C-RNTI group that the C-RNTI used by the subscriber belongs to, then the network end will send the C-RNTI re-allocation message (405) to allocate a new C-RNTI in other groups to the user equipment.

The C-RNTI allocation method proposed by this invention has another embodiment mode. In this mode, the operation steps corresponding to the base station are shown in FIG. 2.

First, the base station acquires the grouping mode of the C-RNTI allocated to the user equipment (501). The C-RNTI grouping mode sent to the user equipment acquired by the base station can be fixed according to specifications. In addition, the network end may configure the grouping mode and inform it to the base station and the user equipment can determine the grouping mode itself. For example, the base station may determine the C-RNTI grouping mode according to its own configuration of random sequence and random channel, or according to the configuration of random sequence and/or the configuration of random channel of other nodes in the network end.

After that, the base station receives the random access preamble sequence from the user equipment and determines the C-RNTI group corresponding to the random access request (502).

Then, the base station determines the C-RNTI group allocated to the user equipment, and chooses a C-RNTI to send the C-RNTI assignment to the user equipment (503).

In step 503, the C-RNTI assignment that the base station sends to the user equipment can be transmitted in the response message of the random access preamble sequence, also it can be transmitted in the response message of Layer2/Layer3 (L2/L3) message that the base station sends to the user equipment.

If the transmission occurs in the response message of the random access preamble sequence, then the C-RNTI allocation can be transmitted through Layer1/Layer2 (L1/L2) control channel also can be transmitted through the downlink shared data channel.

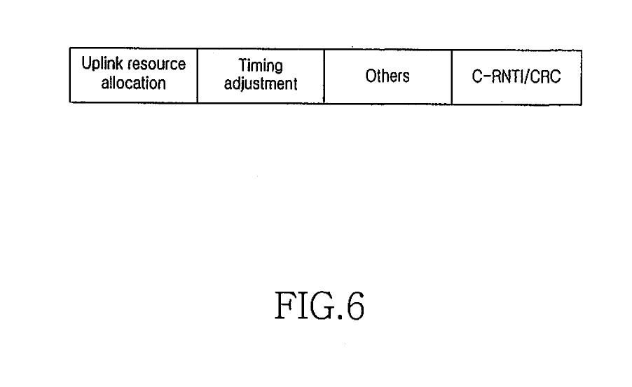

If the transmission occurs in the L1/L2 control channel, then the specific realization of this step is: choosing a usable C-RNTI as the C-RNTI for the user equipment in the determined C-RNTI group to send the L1/L2 control signal and the response of the random preamble sequence to the user equipment. In this step, the sent response message of the random preamble sequence contains: uplink resource allocation, timing adjustment, C-RNTI, and other possible information. In the above description, the C-RNTI will have XOR operation with the mask Cyclical Redundancy Check (mask CRC), and be transmitted together. In this step, the format of the response message that the base station sends to the user equipment is shown in FIG. 6.

It should be noted that according to the above allocation method of C-RNTI grouping, there may be C-RNTI exhaustion in a certain C-RNTI group. To avoid the occurrence of such C-RNTI exhaustion, the above allocation method may include step of: the base station sending C-RNTI re-allocation signaling to the user equipment that had completed the process of random access.

The base station sends the C-RNTI re-allocation signaling to the user equipment that has completed the process of random access. The user equipment can use the C-RNTI in other groups and release the C-RNTI in the primary C-RNTI group, which can avoid C-RNTI allocation exhaustion in some C-RNTI groups.

In the second mode of the method proposed by this invention, to group the C-RNTI, first, a subset of the whole C-RNTI space, {C-RNTIₙ,Nₛₜₐᵣₜ≦n≦N_{end}}, should be used for the C-RNTI grouping space. The C-RNTI in this grouping space can be used both in the process of random access and after the random access process. Then this C-RNTI should be grouped. While the C-RNTI without being grouped will not be allocated to the subscribers in the initial random access process as the initial C-RNTI allocation. It will be allocated to the user equipments after the random access process only when the C-RNTI re-allocation occurs.

The following modes of grouping C-RNTI grouping space are as following:

Mode 1 of grouping C-RNTI grouping space:

C-RNTI space grouping mode 1 is a grouping mode based on random access preamble sequence. It is assumed that the number of preamble sequence for grouping is N_{RS}, and then mode of grouping can be given as shown in Formula (1). It is assumed that the index of the C-RNTI in the whole C-RNTI space is n, and the subset that the C-RNTI grouping space belongs to is {C-RNTIₙ,Nₛₜₐᵣₜ≦n≦N_{end}}, 0≦N_{Start}<N_{T},0<N_{end}≦N_{T}, then in this C-RNTI grouping space, then the index of that CRNTI (whose index is n) in the group is n_{g}:

n_{g}=n mod N_{RS} Nₛₜₐᵣₜ≦n≦N_{end} (4)

Mode 2 of grouping C-RNTI grouping space:

C-RNTI space grouping mode 2 is a grouping mode based on the combination of the random access preamble sequence and transmission sub-frame (or frame). The purpose of C-RNTI grouping based on transmission sub-frame (or transmission frame) is to group the C-RNTI group referring to the time of random access. It is assumed that the number of the preamble sequences for grouping is N_{RS}, while the number of sub-frames (or frame) of random access in a period of random access transmission is N_{FN}, then a grouping mode can be gotten as shown in Formula (5). It is assumed that the index of the C-RNTI in the whole C-RNTI space is n, and the subset that the C-RNTI grouping space belongs to is {C-RNTIₙ,Nₛₜₐᵣₜ≦n≦N_{end}}, 0≦Nₛₜₐᵣₜ<N_{T},0<N_{end}≦N_{T}, then in this C-RNTI grouping space, then the index of that CRNTI (whose index is n) in the group is n_{g}:

n_{g}=n mod(N_{RS}*N_{FN}) Nₛₜₐᵣₜ≦n≦N_{end} (5)

Grouping mode 3 of C-RNTI grouping space:

C-RNTI space grouping mode 3 is a grouping mode based on the combination of the random access preamble sequence, transmission sub-frame (or frame) and transmitted random access channel serial number in frequency domain. The purpose of C-RNTI grouping based on the random access channel serial number in frequency domain is to group the C-RNTI group referring to the frequency reference to the RA. It is assumed that the number of the preamble sequence for grouping is N_{RS}, the number of sub-frames (or frame) of random access in a period of random access transmission is N_{FN}, and the number of random access channels in the same random access transmission sub-frame (or frame) is N_{CN}, then a grouping mode may be obtained as shown in Formula (6). It is assumed that the index of the C-RNTI in the whole C-RNTI space is n, and the subset that the C-RNTI grouping space belongs to is {C-RNTIₙ,Nₛₜₐᵣₜ≦n≦N_{end}}, 0≦Nₛₜₐᵣₜ<N_{T},0<N_{end}≦N_{T}, then in this C-RNTI grouping space, then the index of that CRNTI (whose index is ii) in the group is n_{g}:

n_{g}=n mod(N_{RS}*N_{FN}*N_{CN}) Nₛₜₐᵣₜ≦n≦N_{end} (6)

As shown in Table 1, the random access preamble sequence may indicate different causes. Some of the causes show that the user equipment has C-RNTI, while some causes show that the user equipment does not have C-RNTI. It is assumed that the number of sequence which indicates that the user equipment does not have C-RNTI is N_{NC}, and then the number of preamble sequence for grouping in the three kinds of C-RNTI grouping modes given here is N_{RS}. N_{RS} can be equal to N_{NC}, or be less than N_{NC}.

Using the given C-RNTI grouping mode, when receiving the random access preamble sequence sent by the user equipment, the network end can determine the group that the C-RNTI needed to be allocated to the subscriber belongs to according to the preamble sequence, or the combination of the preamble sequence and transmission sub-frame (or frame), or the combination of preamble sequence, transmission sub-frame (frame) and the serial number of the random access channel in frequency domain, and then choose a unused C-RNTI in this group and take the C-RNTI as the identity number of the user equipment, send the response message of the random access preamble sequence to the user equipment through the L1/L2 control channel.

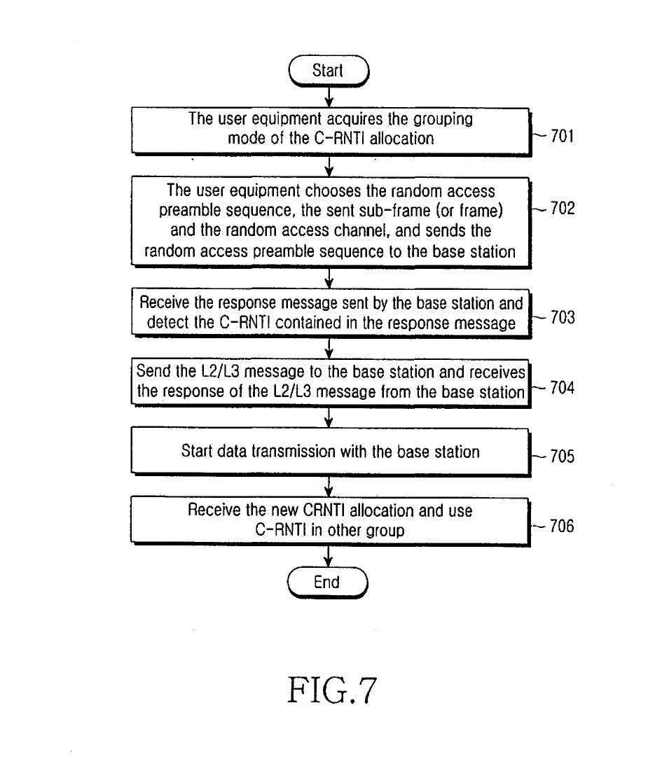

This invention gives the operation flow of the user equipment in the second mode of C-RNTI allocation method, as shown in FIG. 7.

First, the user equipment acquires the grouping mode of the C-RNTI allocation (701). The C-RNTI grouping mode acquired by the user equipment may be fixed according to specifications. The network end also may configure the grouping mode and inform it to the user equipment. In addition, the user equipment may determine the grouping mode itself according to the configuration of random sequence and/or the configuration of random channel of the network end.

After that, when the random access is need to be initiated, the user equipment chooses the random access preamble sequence, the transmission sub-frame (or frame), and the random access channel, and sends the random access preamble sequence to the base station (702).

Then, the user equipment receives the response message sent by the base station and detects the C-RNTI contained in the response message (703). The method of identifying the C-RNTI for the user equipment may include steps of: first determining the C-RNTI group corresponding to the random access preamble sequence according to the transmission of the random access preamble sequence, then detecting the field contained in the response message of the preamble sequence and the CRC mask by using all the C-RNTI contained in the group, so as to identify the C-RNTI contained in this message.

After that, the user equipment will send the L2/L3 message to the base station and receive the response of the L2/L3 message from the base station (704).

After the user equipment completes the random access process, the data transmission will be started between the user equipment and the base station (705).

After completing the random access process, if the base station allocates a new C-RNTI to the user equipment, the user equipment receives the new C-RNTI sent by the base station and uses the new C-RNTI (706).

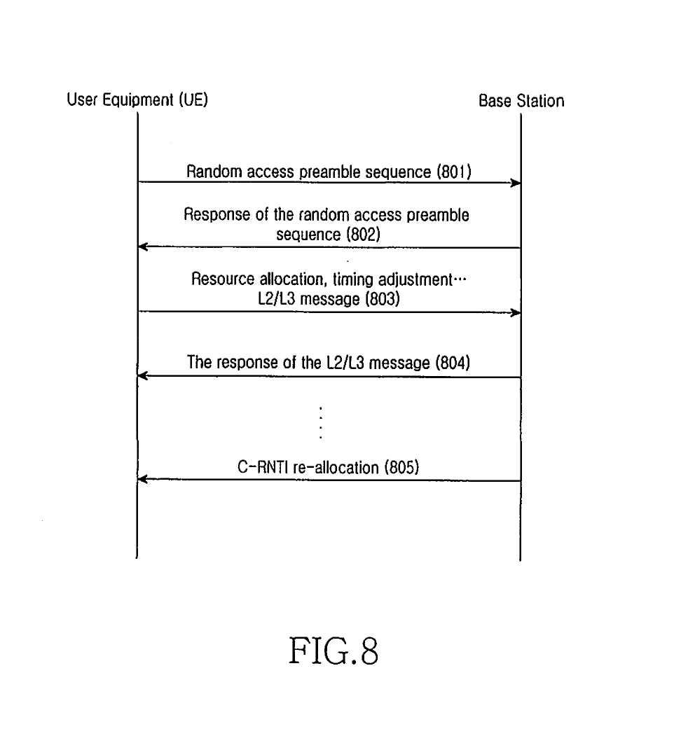

This invention provides a signaling interaction process between the base station and the user equipment in the second mode of C-RNTI allocation method, as shown in FIG. 8.

First, the user equipment sends a random access preamble sequence to the base station (801).

After that, the base station sends the response message of the random access preamble sequence to the user equipment (802). The message contains: uplink resource allocation, timing adjustment, and serial number of the C-RNTI in the group that the base station allocated to the user equipment. In the message, the C-RNTI will be together with the CRC mask.

After that, the user equipment will send L2/L3 message to the network end (803).

Then, the network end will send the response for the L2/L3 message to the user equipment (804).

After the user equipment has completed the random access process, if the C-RNTI is almost exhausted in the C-RNTI group that the C-RNTI used by the user equipment belongs to, then the network end will send the C-RNTI re-allocation message (805) to allocate a new C-RNTI in other groups to the user equipment.

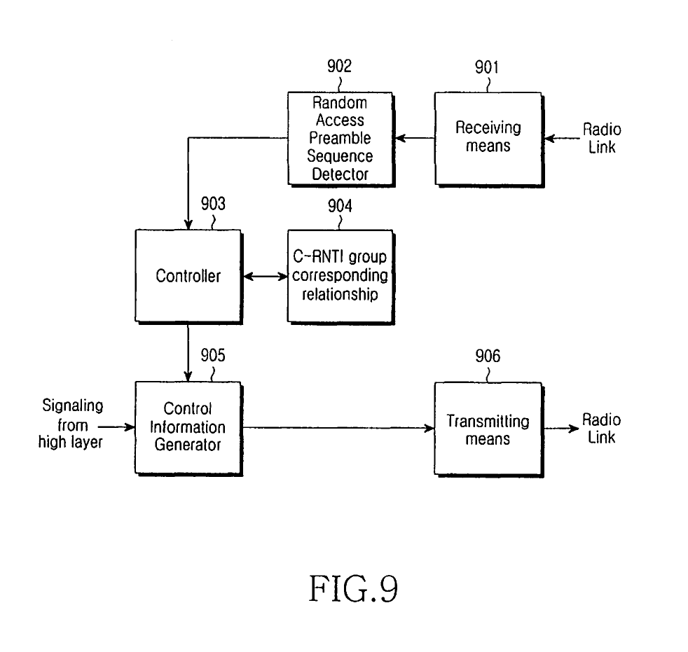

This invention also gives a hardware block diagram for implementing the base station used for the CRNTI allocation method according to present invention, as shown in FIG. 9.

A receiving means 901 of the base station receives the random access preamble sequence sent by the user equipment, inputs it to the random access preamble sequence detector 902, determines the random access preamble sequence sent by the subscriber, or the combination of the random access preamble sequence and transmission sub-frame (or frame), or the combination of the random access preamble sequence, transmission sub-frame (or frame) and the serial number of the random access channel in frequency domain, then sends the detecting result to the controller 903. A controller 903 will determine the C-RNTI allocated to the user equipment by referring to the random access preamble sequence, or the combination of the random access preamble sequence and transmission sub-frame (or frame), or the combination of the random access preamble sequence, transmission sub-frame (or frame) and the serial number of the random access channel in frequency domain, and the corresponding relationship 904 with the C-RNTI group, and sends the determined C-RNTI to the control information generator 905 to generate control information of C-RNTI allocation, then sends it to the user equipment through the transmitting means 906.

### EMBODIMENTS

To explain the method in this invention, the following gives embodiments of the C-RNTI allocation method proposed by this invention. In the given embodiment, it is assumed that the number of the C-RNTI in the C-RNTI space of the assumed system is 2¹⁶=65536. That is to say that it needs 16 bits to indicate in the case that the system sends a C-RNTI allocation. For example, according to the present technologies, the network end transmits “00000000 00000101” to a user equipment in the signaling of C-RNTI allocation, which means that the network end allocates the C-RNTI whose index is 5 among the 65526 C-RNTI to the user equipment.

First, an embodiment of the first C-RNTI allocation method proposed by this invention is given.

### Embodiment 1

Here gives the following assumptions:

Send the random access preamble sequence once every 10 ms;

At each 10 ms interval, there are four sub-frames which can be used to send the random access preamble sequence;

There is one random access channel (a frequency band of 1.25 MHz) in each sub-frame which can be used to send the random access preamble sequence;

There are 64 random access preamble sequences that the system can use. And 32 ones among the sequences are used to initiate the asynchronous random access request for the C-RNTI allocation (the user equipment have not C-RNTI).

According to the above assumptions, the C-RNTI space may be grouped according to the method proposed by this invention, as shown in the following table:

TABLE 5
C-RNTI space grouping mode of the first C-RNTI allocation method
implementing mode proposed by this invention in the embodiment

| | Transmission sub-frame | | | | | | | |
|---|---|---|---|---|---|---|---|---|
| | Transmission sub-frame 1 | | | | Transmission sub-frame 2 | | | |
| | Preamble sequence | | | | Preamble sequence | | | |
| C-RNTI | Sequence | Sequence | | Sequence | Sequence | Sequence | | Sequence |
| allocation | 1 | 2 | | 32 | 1 | 2 | | 32 |
| indication | Group | Group | . . . | Group | Group | Group | . . . | Group |
| (Binary bits) | 1 | 2 | . . . | 32 | 33 | 34 | . . . | 64 |
| 00000 0000 | C-RNTI | C-RNTI | . . . | C-RNTI | C-RNTI | C-RNTI | . . . | C-RNTI |
| | 1 | 2 | | 32 | 33 | 34 | | 64 |
| 00000 0001 | C-RNTI | C-RNTI | . . . | C-RNTI | C-RNTI | C-RNTI | . . . | C-RNTI |
| | 129 | 130 | | 160 | 161 | 162 | | 192 |
| 00000 0010 | C-RNTI | C-RNTI | . . . | C-RNTI | C-RNTI | C-RNTI | . . . | C-RNTI |
| | 257 | 258 | | 288 | 289 | 290 | | 320 |
| . . . | . . . | . . . | . . . | . . . | . . . | . . . | . . . | . . . |
| 11111 1110 | C-RNTI | C-RNTI | . . . | C-RNTI | C-RNTI | C-RNTI | . . . | C-RNTI |
| | 65025 | 65026 | | 65056 | 65057 | 65058 | | 65088 |
| | Transmission sub-frame | | | | | | | |
| | Transmission sub-frame 3 | | | | Transmission sub-frame 4 | | | |
| | Preamble sequence | | | | Preamble sequence | | | |
| C-RNTI | Sequence | Sequence | | Sequence | Sequence | Sequence | | Sequence |
| allocation | 1 | 2 | | 32 | 1 | 2 | | 32 |
| indication | Group | Group | . . . | Group | Group | Group | . . . | Group |
| (Binary bits) | 65 | 66 | . . . | 96 | 97 | 98 | . . . | 128 |
| 00000 0000 | C-RNTI | C-RNTI | . . . | C-RNTI | C-RNTI | C-RNTI | . . . | C-RNTI |
| | 65 | 66 | | 96 | 97 | 98 | | 128 |
| 00000 0001 | C-RNTI | C-RNTI | . . . | C-RNTI | C-RNTI | C-RNTI | . . . | C-RNTI |
| | 193 | 194 | | 324 | 325 | 326 | | 256 |
| 00000 0010 | C-RNTI | C-RNTI | . . . | C-RNTI | C-RNTI | C-RNTI | . . . | C-RNTI |
| | 321 | 322 | | 452 | 453 | 454 | | 384 |
| . . . | . . . | . . . | . . . | . . . | . . . | . . . | . . . | . . . |
| 11111 1110 | C-RNTI | C-RNTI | | C-RNTI | C-RNTI | C-RNTI | | C-RNTI |
| | 65249 | 65250 | | 65280 | 65249 | 65250 | | 65408 |

As shown in the above table, the 65536 C-RNTI in the C-RNTI allocation space are divided into 32×4=128 groups according to the different random access preamble sequence sent by the user equipment and different chosen transmission sub-frames, and each group has 65536/128=512 C-RNTI.

If both the base station and the user equipment acquire the above C-RNTI grouping mode, C-RNTI allocation and detection may be initiated.

After detecting the random access preamble sequence sent by the user equipment, the base station may determine the C-RNTI grouping allocated to itself according to the random access preamble sequence chosen by the user equipment, its transmission sub-frame and the grouping relationship in Table 5. After that, the base station may choose an unallocated C-RNTI in the C-RNTI group, and send the 9-bit binary number corresponding to the index of the C-RNTI in the group to the user equipment through the signaling of allocating C-RNTI to the user equipment, so as to indicate C-RNTI allocation using 9-bit binary number, which has 7-bit signaling overhead less than the traditional method using 16-bit binary number to indicate C-RNTI allocation.

After sending the random access preamble sequence, the user equipment can determine the corresponding group according to its random access preamble sequence, the transmission sub-frame and the grouping relationship in Table 5. When the user equipment receives the 9-bit binary index which is sent by the base station through the signaling of C-RNTI allocation to the user equipment, it will detect the C-RNTI allocated to itself by the base station.

It should be noted that the network end will send C-RNTI re-allocation signaling to the user who has access to the network, so as to re-allocate a more unoccupied group in which less C-RNTI are used when it finds that the C-RNTI are almost exhausted in a certain C-RNTI group.

### Embodiment 2

Here gives the following assumptions:

Send the random access preamble sequence once every 10 ms;

In each 10 ms interval, there are four sub-frames which can be used to send the random access preamble sequence;

There is one random access channel (a frequency band of 1.25 MHz) in each sub-frame which can be used to send the random access preamble sequence;

There are 64 random access preamble sequences that the system can use. And 32 ones among the sequences are used to launch the asynchronous random access request for the C-RNTI allocation (the user equipment have not C-RNTI).

According to the above assumptions, the C-RNTI space may be grouped according to the method proposed by this invention, as shown in the following table 5:

As shown in the above table 5, the 65536 C-RNTI in the C-RNTI allocation space are divided into 32×4=128 groups according to the different random access preamble sequence sent by the user equipment and different chosen transmission sub-frames, each group has 65536/128=512 C-RNTI.

If both the base station and the user equipment acquire the above C-RNTI grouping mode, the C-RNTI allocation and detection may be intiated.

First, the user equipment sends the random access preamble sequence to the base station. After that, the base station receives the random access preamble sequence sent by the user equipment. According to the method in this invention, there is a CRNTI group corresponding to the random access preamble sequence sent by the user equipment. Table 5 is taken as an example, there is a CRNTI group corresponding to the combination of the random access preamble sequence and the sub-frame sent by the user equipment. After detecting the random access preamble sequence sent by the user equipment, the base station can determine the C-RNTI group that should be allocated to the user equipment, according to the chosen random access preamble sequence and the transmission sub-frame by the user equipment, and the grouping relationship in Table 5. After that, an unallocated C-RNTI will be chosen in this C-RNTI group, and the CRNTI assignment information will be sent in the response message of the random access preamble sequence to the user equipment. The combination of this CRNTI assignment information and the random access preamble sequence ID will indicate the CRNTI allocated by the base station. In this way, the response message of the random access preamble sequence will contain the following contents:

Uplink resource assignment (UL RA), Timing adjustment (TA), Random access preamble ID (RA_ID), and information combined with RA_ID to indicate CRNTI.

In this embodiment, the information combined with RA_ID to indicate CRNTI could be the index of the CRNTI in the CRNTI group. The CRNTI group in this embodiment is the CRNTI group determined by the combination of the transmission sub-frames of the random access preamble sequence and the RA_ID.

In this embodiment, the CRNTI group corresponding to the random access preamble sequence only contains the CRNTI with the number of 2⁹=512. Thus the index of the CRNTI in the CRNTI group allocated to the user equipment is a 9 bits binary number.

The 9 bits binary number corresponding to the index of the C-RNTI in the group is sent to the user equipment through the signaling of allocating C-RNTI to the user equipment, so as to realize to indicate C-RNTI allocation using 9 binary bits, which has 7 bits signaling overhead less than the traditional method using 16 binary bits to indicate C-RNTI allocation.

After sending the random access preamble sequence, the user equipment may determine the corresponding C-RNTI group according to its random access preamble sequence and transmission sub-frames and the grouping relationship in Table 5. After that, the user equipment may receive the response message of the random access preamble sequence sent by the base station to detect if the sent RA_ID is contained in the message. If the sent RA_ID has been detected, the CRNTI assignment information allocated to the user equipment and contained in this response message can be determined. After that, the user equipment will detect CRNTI assignment information that the base station sends to it in the message, and determine the CRNTI allocated by the base station according to this information and the sent random access preamble sequence ID. More specifically, the user equipment determines the CRNTI group according to the combination of the RA_ID and the transmission sub-frames of the random access preamble sequence and the corresponding relationship in Table 5, and then determines the CRNTI allocated to it by the base station according to the index (9 bits binary number) of the CRNTI in the CRNTI group sent by the base station in the response message of the random access preamble sequence.

It should be noted that the network end will send C-RNTI re-allocation signaling to the user who has access to the network, so as to re-allocate a more unoccupied group in which less C-RNTI are used when it finds that the C-RNTI are almost exhausted in a certain C-RNTI group.

### Embodiment 3

Here gives the following assumptions:

There are 64 random access preamble sequences available for the system.

According to the above assumptions, the C-RNTI space can be grouped according to the method according to this invention, as shown in the following table 7:

TABLE 7
Grouping models of the C-RNTI space in the embodiment example 3

| C-RNTI | Preamble sequence | | | |
|---|---|---|---|---|
| allocation | Sequence 0 | Sequence 1 | | Sequence 63 |
| indication | Group 0 | Group 1 | . . . | Group 63 |
| 0000 0 00000 | C-RNTI 0 | C-RNTI 1 | . . . | C-RNTI 63 |
| 0000 0 00001 | C-RNTI 64 | C-RNTI 64 + 1 | . . . | C-RNTI 2*64 − 1 |
| 0000 0 00010 | C-RNTI 2*64 | C-RNTI 2*64 + 1 | . . . | C-RNTI 3*64 − 1 |
| 0000 0 00011 | C-RNTI 3*64 | C-RNTI 3*64 + 1 | . . . | C-RNTI 4*64 − 1 |
| . . . | . . . | . . . | . . . | . . . |
| 1111 1 11110 | C-RNTI 1022*64 | C-RNTI 1022*64 + 1 | . . . | C-RNTI 1023*64 − 1 |
| 1111 1 11111 | C-RNTI 1023*64 | C-RNTI 1023*64 + 1 | | C-RNTI 1024*64 − 1 |

As shown in Table 7, the 65536 C-RNTI in the C-RNTI allocation space are divided into 64 groups according to the different random access preamble sequences sent by different user equipment, and each group has 65536/64=1024 C-RNTI.

If both the base station and the user equipment acquire the above C-RNTI grouping mode, the C-RNTI allocation and detection may be initiated.

First, the user equipment sends the random access preamble sequence to the base station. After that, the base station receives the random access preamble sequence that the user equipment sends. According to the method in this invention, there is a CRNTI group corresponding to the random access preamble sequence sent by the user equipment. Table 7 is taken as an example, there is a CRNTI group corresponding to the random access preamble sequence sent by the user equipment. After detecting the random access preamble sequence sent by the user equipment, the base station can determine the C-RNTI group that should be allocated to the user equipment, according to the random access preamble sequence chosen by the user equipment, and the grouping relationship in Table 7. After that, an unallocated C-RNTI will be chosen in this C-RNTI group, and the CRNTI assignment information will be sent in the response message of the random access preamble sequence to the user equipment. The combination of this CRNTI assignment information and the random access preamble sequence ID will indicate the CRNTI allocated by the base station. In this way, the response message of the random access preamble sequence will contain the following contents:

Uplink resource assignment (UL RA), Timing adjustment (TA), Random access preamble ID (RA_ID), and information combined with RA_ID to indicate CRNTI.

In this embodiment, the information combined with RA_ID to indicate CRNTI could be the index of the CRNTI in the CRNTI group. The CRNTI group in this embodiment is the CRNTI group determined by the RA_ID.

In this embodiment, the CRNTI group corresponding to the random access preamble sequence only contains the CRNTI with the number of 2¹⁰=1024. Thus the index of the CRNTI in the CRNTI group allocated to the user equipment is a 10 bits binary number.

It is supposed that the RA_ID sent from the user equipment to the base station is 1. Since there are 2⁶=64 random access preamble sequences in this embodiment, the RA_ID may be transformed to a 6 bits binary number “000001”. That is to say, the random access preamble sequence ID RA_ID sent by the user equipment is “000001”.

After receiving the random access preamble sequence sent by the user equipment, the base station will determine that the CRNTI allocated to the user equipment is in CRNTI group 1. It is supposed that the C-RNTI 1022*64+1 (C-RNTI 65409) in group 1 has been allocated to the user equipment. Then the response message sent from the base station to the user equipment will contain the following contents:

Uplink resource assignment (UL RA);

Timing adjustment (TA);

The chosen index of the CRNTI allocated to the user equipment in the CRNTI group is “11111 11110” (the index is 1022);

Random access preamble ID (RA_ID), that is “000001” (RA_ID 1).

In this way, with the index of the indicated CRNTI in the CRNTI group “11111 11110” as the first 10 bits of the 16 bits CRNTI, and with the RA_ ID “000001” as the last 6 bits of the 16 bits CRNTI, both of the two parts consist the CRNTI “1111111110000001” (CRNTI 65409) needed to be allocated.

It should be noted that the above embodiment uses the RA_ID as the last 6 bits of the CRNTI, and uses the index in the CRNTI group as the first 10 bits of the CRNTI. Using the similar methods gives the different grouping model, the RA_ID may be used as the first 6 bits of the CRNTI, and the index in the CRNTI group can be used as the last 10 bits of the CRNTI.

After sending the random access preamble sequence, the user equipment can determine the corresponding C-RNTI group according to its sent random access preamble sequence and the grouping relationship in Table 7. After that, the user equipment can receive the response message of the random access preamble sequence sent by the base station to detect if the sent RA_ID is contained in the message. If the sent RA_ID has been detected, the CRNTI assignment information allocated to the user equipment and contained in this response message can be determined. After that, the user equipment will detect CRNTI assignment information that the base station sends to it in the message, and determine the CRNTI allocated by the base station according to this information and the sent random access preamble sequence ID. More specifically, the user equipment determines the CRNTI group according to the combination of the RA_ID and the transmission sub-frame of the random access preamble sequence and the corresponding relationship in Table 7, and then determines the CRNTI allocated to it by the base station according to the index (10 bits binary number) of the CRNTI in the CRNTI group sent by the base station in the response message of the random access preamble sequence.

It should be noted that the network end will send C-RNTI re-allocation signaling to the user who has access to the network, so as to re-allocate a more unoccupied group in which less C-RNTI are used when it finds that the C-RNTI are almost exhausted in a certain C-RNTI group.

Secondly, the embodiment of the second implementing method of the C-RNTI allocation method proposed by this invention is given. Here gives the following assumptions:

Send the random access preamble sequence once every 10 ms;

In each 10 ms interval, there are four sub-frames which can be used to send the random access preamble sequence;

There is one random access channel (a frequency band of 1.25 MHz) in each sub-frame which can be used to send the random access preamble sequence;

There are 64 random access preamble sequences that the system can use. 32 ones among the sequences are used to initiate the asynchronous random access request for the C-RNTI allocation (the user equipment have not C-RNTI).

According to the above assumptions, the index from 1 to 1024 among the whole C-RNTI space containing 65536 C-RNTI can be chosen as special C-RNTI allocation space according to the method in this invention. The C-RNTI in this special C-RNTI space can be used both in the process of random access and after the random access process. After that, the special C-RNTI space can be grouped as following:

TABLE 6
C-RNTI space grouping mode of the second C-RNTI allocation
method implementing mode proposed by this invention in the embodiment
Transmission sub-frame

| Transmission sub-frame 1 | | | | Transmission sub frame 2 | | | |
|---|---|---|---|---|---|---|---|
| Preamble sequence | | | | Preamble sequence | | | |
| Sequence | Sequence | | Sequence | Sequence | Sequence | | Sequence |
| 1 | 2 | | 32 | 1 | 2 | | 32 |
| Group | Group | — | Group | Group | Group | — | Group |
| 1 | 2 | — | 32 | 33 | 34 | — | 64 |
| C-RNTI | C-RNTI | — | C-RNTI | C-RNTI | C-RNTI | — | C-RNTI |
| 1 | 2 | | 32 | 33 | 34 | | 64 |
| C-RNTI | C-RNTI | — | C-RNTI | C-RNTI | C-RNTI | — | C-RNTI |
| 129 | 130 | | 160 | 161 | 162 | | 192 |
| C-RNTI | C-RNTI | — | C-RNTI | C-RNTI | C-RNTI | — | C-RNTI |
| 257 | 258 | | 288 | 289 | 290 | | 320 |
| C-RNTI | C-RNTI | — | C-RNTI | C-RNTI | C-RNTI | — | C-RNTI |
| 385 | 386 | | 416 | 417 | 418 | | 448 |
| C-RNTI | C-RNTI | — | C-RNTI | C-RNTI | C-RNTI | — | C-RNTI |
| 513 | 514 | | 544 | 545 | 546 | | 576 |
| C-RNTI | C-RNTI | — | C-RNTI | C-RNTI | C-RNTI | — | C-RNTI |
| 641 | 615 | | 672 | 673 | 674 | | 704 |
| C-RNTI | C-RNTI | — | C-RNTI | C-RNTI | C-RNTI | — | C-RNTI |
| 769 | 770 | | 800 | 801 | 802 | | 832 |
| C-RNTI | C-RNTI | — | C-RNTI | C-RNTI | C-RNTI | — | C-RNTI |
| 897 | 898 | | 928 | 929 | 930 | | 960 |
| Transmission sub-frame 3 | | | | Transmission sub frame 4 | | | |
| Preamble sequence | | | | Preamble sequence | | | |
| Sequence | Sequence | | Sequence | Sequence | Sequence | | Sequence |
| 1 | 2 | | 32 | 1 | 2 | | 32 |
| Group | Group | — | Group | Group | Group | — | Group |
| 65 | 66 | — | 96 | 97 | 98 | — | 128 |
| C-RNTI | C-RNTI | — | C-RNTI | C-RNTI | C-RNTI | — | C-RNTI |
| 65 | 66 | | 96 | 97 | 98 | | 128 |
| C-RNTI | C-RNTI | — | C-RNTI | C-RNTI | C-RNTI | — | C-RNTI |
| 193 | 194 | | 324 | 325 | 326 | | 256 |
| C-RNTI | C-RNTI | — | C-RNTI | C-RNTI | C-RNTI | — | C-RNTI |
| 321 | 322 | | 452 | 453 | 454 | | 384 |
| C-RNTI | C-RNTI | — | C-RNTI | C-RNTI | C-RNTI | — | C-RNTI |
| 449 | 450 | | 580 | 581 | 582 | | 512 |
| C-RNTI | C-RNTI | — | C-RNTI | C-RNTI | C-RNTI | — | C-RNTI |
| 577 | 578 | | 708 | 709 | 710 | | 640 |
| C-RNTI | C-RNTI | — | C-RNTI | C-RNTI | C-RNTI | — | C-RNTI |
| 705 | 706 | | 836 | 837 | 838 | | 768 |
| C-RNTI | C-RNTI | — | C-RNTI | C-RNTI | C-RNTI | — | C-RNTI |
| 833 | 834 | | 964 | 965 | 966 | | 896 |
| C-RNTI | C-RNTI | — | C-RNTI | C-RNTI | C-RNTI | — | C-RNTI |
| 961 | 962 | | 1092 | 1093 | 1094 | | 1024 |

As shown in the above table, there are 1024 C-RNTIs in the special allocation space. The special space is divided into 32×4=128 groups according to different random access preamble sequences sent by the user equipment and chosen different transmission sub-frames, each group has 1024/128=8 C-RNTIs.

If both the base station and the user equipment acquire the above C-RNTI grouping mode, the C-RNTI allocation and detection can be initiated.

After detecting the random access preamble sequence sent by the user equipment, the base station may determine the group allocated to itself according to the random access preamble sequence chosen by the user equipment, its transmission sub-frames and the grouping relationship in Table 6. After that, the base station can choose an unallocated C-RNTI in the C-RNTI group, and send it to the user equipment through the response message of the random access preamble sequence.

In this embodiment, the C-RNTI is transmitted to the user equipment through Layer1/Layer2 (L1/L2) control channel. The C-RNTI can act as the user equipment identity (UE ID) to send L1/L2 control channel identity to the user equipment, and allocate C-RNTI to the user equipment.

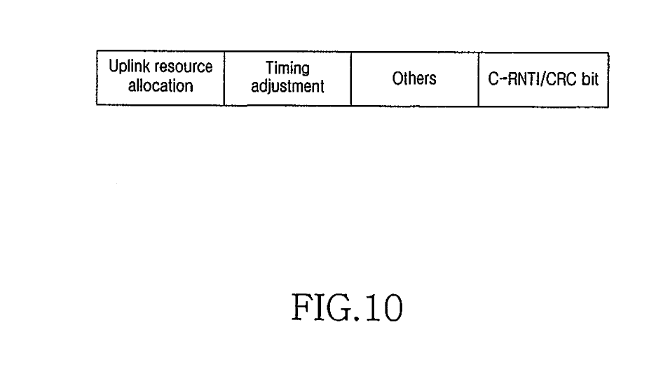

The sent C-RNTI will have XOR operation with the mask Cyclical Redundancy Check (mask CRC), and be transmitted together. If the sent C-RNTI and CRC mask are transmitted in L1/L2 control channel, then the format of the response message of the random access preamble sequence is shown in FIG. 10. The response message transmitted in L1/L2 control channel will contain:

Uplink resource allocation;

Timing adjustment;

C-RNTI and mask bits of Cyclic Redundancy bits;

Others.

After sending the random access preamble sequence, the user equipment can determine the corresponding group according to its random access preamble sequence, the transmission sub-frame and the grouping relationship in Table 6. When the user equipment receives the response message of the random access preamble sequence which is sent by the base station, it will take turns to have mask and CRC operation between the 8 C-RNTI and the response message of the random sequence so as to detect the transmitted C-RNTI in the response message and acquire the C-RNTI allocated by the base station to itself.

It should be noted that, when the network end finds that the C-RNTI are almost exhausted in a certain C-RNTI group, it will send C-RNTI re-allocation signaling to the subscriber who has access to the network, re-allocate C-RNTI in non C-RNTI group space to the subscriber, release C-RNTI in the originally used special space to avoid the above exhaustion.

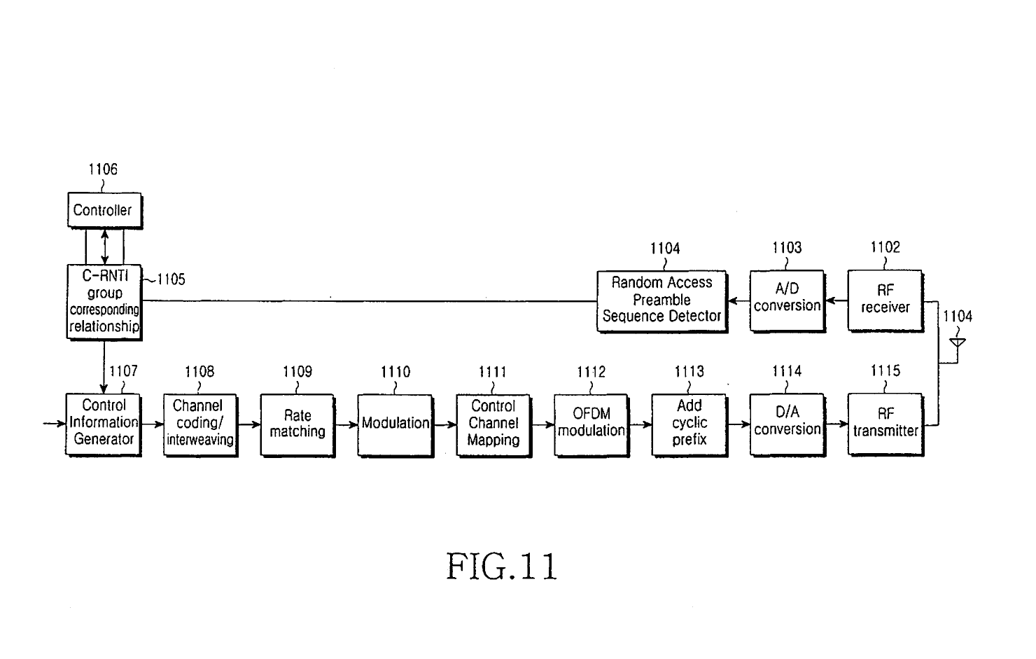

The following gives the hardware implementation block diagram to allocate CRNTI in the base station, as shown in FIG. 11.

First, the base station receives the random access preamble sequence sent by the user equipment through the receiving means (1101 Antenna, and 1102 Analog/Digital Conversion), and detects the random access preamble sequence in the 1103 Random Access Preamble Sequence Detector, then transmits it to the 1104 Controller.

Grouping corresponding relationship between the random access preamble sequences, the transmission sub-frame, the sent random access channel and C-RNTI will be stored in 1105 random access preamble sequence corresponding relationship module. After the base station determines the random access preamble sequence sent by the user equipment, the transmission sub-frame and the random access channel, the 1104 Controller will determine the C-RNTI group allocated to the user equipment according to the grouping corresponding relationship between the random access preamble sequence, the transmission sub-frame, the sent random access channel and C-RNTI stored in 1105 random access preamble sequence corresponding relationship module, choose a proper C-RNTI assignment among the group, and send the C-RNTI assignment information to 1107 Control Information Creator to generate C-RNTI allocation control information. The control information will be sent to the user equipment through the transmitting set, including 1108 Channel Coding/Interleaving Module, 1109 Rate Matching Module, 1110 Modulation Module, 1111 Control Channel Mapping Module, 1112 OFDM Modulation Module, 1113 Cyclic Prefix Adding Module, 1114 D/A Conversion Module, 1115 RF Transmitter Module and 1101 Antenna.

What is claimed is:

1. A method for allocating a C-RNTI by a base station, comprising steps of:
a) a user equipment sending a random access preamble sequence to the base station;
b) the base station sending a response message of the random access preamble sequence to the user equipment, the message including Uplink resource assignment information, Timing adjustment information, and information combined with a Random access preamble sequence ID to indicate the CRNTI;
c) the user equipment sending a L3 message to a network end; and
d) the network end sending a response of the L3 message to the user equipment.

2. The method according to claim 1, wherein in Step b), the information combined with the random access preamble sequence ID to indicate the CRNTI is a index of a allocated CRNTI in a specific CRNTI group.

3. The method according to claim 1, wherein in Step b), the response message sent from the base station to the user equipment further includes a random access preamble sequence ID.

4. The method according to claim 2, wherein a grouping model of the C-RNTI group consist in that a whole C-RNTI space is used as a C-RNTI grouping space to perform grouping.

5. The method according to claim 2, wherein a grouping model of the C-RNTI group consists in that a subset of a whole C-RNTI space is used as a C-RNTI grouping space to perform grouping.

6. The method according to claim 2, wherein a grouping model of the C-RNTI group consists in that a CRNTI grouping space is grouped based on the random access preamble sequence.

7. The method according to claim 2, wherein, the specific C-RNTI group is a C-RNTI group corresponding to the random access preamble sequence received by the base station.

8. The method according to claim 2, wherein a grouping model of the C-RNTI group consists in that a CRNTI grouping space is grouped based on a combination of the random access preamble sequence and a transmission sub-frame of the preamble sequence.

9. The method according to claim 2, wherein, the specific C-RNTI group is a C-RNTI group corresponding to a combination of the random access preamble sequence and a transmission sub-frame of the random access preamble sequence received by the base station.

10. The method according to claim 1, wherein a grouping model of the C-RNTI group consists in that a CRNTI grouping space is grouped based on a combination of the random access preamble sequence, a transmission sub-frame of the preamble sequence and a random access channel.

11. The method according to claim 2, wherein the specific C-RNTI group is a C-RNTI group corresponding to a combination of the random access preamble sequence, a transmission sub-frame of the random access preamble sequence received by the base station and a random access channel transmitted by the preamble sequence.

12. The method according to claim 1, wherein in Step b), the response message of the random access preamble sequence transmitted by the base station is transmitted over a L1/L2 control channel.

13. The method according to claim 1, wherein, in Step b), the response message of the random access preamble sequence transmitted by the base station is transmitted over a downlink shared data channel.

14. A base station apparatus for allocating a C-RNTI, comprising an antenna, a cyclic prefix adding module, an OFDM modulation module, a modulation module, a rate matching module, a channel coding/interleaving module, and further comprising:
a) a random access preamble sequence detector, for detecting random access preamble sequences sent by a user equipment, identifying transmission sub-frames and transmission random access channels;
b) a controller for determining a C-RNTI group of the transmission random access preamble sequence response, choosing a proper C-RNTI in the group, and sending it to a Control Information generator to generate CRNTI allocation control information according to the random access preamble sequence detected by the random access preamble sequence detector, the transmission sub-frame and the transmission random access channel, by referring to a group corresponding relationship determined by a C-RNTI grouping corresponding relation module; and
c) transmitting means for send the control information allocated by the C-RNTI.
